(19) United States
(12) Patent Application Publication
(10) Pub. No.: US 2012/0052826 A1
(43) Pub. Date: Mar. 1, 2012

(54) Communication apparatus having automatic gain control apparatus and automatic gain control method

(75) Inventor: YanYu Chen, Changhua County (TW)

(73) Assignee: Global Unichip Corporation, Hsinchu City (TW)

(21) Appl. No.: 12/929,771

(22) Filed: Feb. 15, 2011

(30) Foreign Application Priority Data
Aug. 26, 2010 (TW) 099128573

(51) Int. Cl. H04B 1/16

(52) U.S. Cl. 455/200.1

(57) ABSTRACT

The invention relates to a communication apparatus having automatic gain control apparatus and automatic gain control method. It comprises a communication apparatus with automatic gain control apparatus, a signal power calculation apparatus to calculate a first power value of the first digital signal. The operation of gain apparatus is based on the first gain value. The channel status decision apparatus decides the first channel status of the first gain value. The first digital signal has an update period of automatic gain control. The demodulator sends out the first channel impulse response to the automatic gain control apparatus. The channel status decision apparatus adjusts the update period of automatic gain control according to the first channel status of the first digital signal.

### BACKGROUND OF THE INVENTION

1. Field of the Invention

The invention relates to a communication apparatus and method, particularly to a communication apparatus having automatic gain control apparatus and automatic gain control method.

2. Description of the Prior Art

In the wireless communication field, due to the obstacle and communication distance among the communication apparatuses, the signal intensity received by the communication apparatus will be influenced. Thus, the signal intensity can not be predicted, it will be varied all the time. Thus, the signal received by the communication apparatus should be adjusted to an ideal value, in order to obtain the best signal at the receiving end.

The conventional solution is to use the automatic gain control (AGC) apparatus in the wireless communication. The automatic gain control apparatus calculates the gain of communication apparatus in accordance with the received signal, in order to adjust the signal intensity to the setup level.

In addition, the traditional automatic gain control apparatus uses fixed AGC update period to receive the signal. However, when the communication apparatus is moving, the signal received by the communication apparatus will have the slow fading and the fast fading, because the speed of communication apparatus is varied at any time.

As shown in FIG. 1A, the communication apparatus 100 having the automatic gain control system 130 of prior art in illustrated. Upon carrying out the automatic gain control, the radio frequency regulator 110 receives the analog signal, which is converted to the digital signal by the analog and digital conversion apparatus 120 and is inputted into the automatic gain control apparatus 130. The automatic gain control apparatus 130 includes the signal power calculation apparatus 1302 and the gain apparatus 1304. After the digital signal is received by the signal power calculation apparatus 1302, the power value of digital signal can be calculated. Then, according to the power value, the gain apparatus 1304 inquires inside corresponding power gain table to obtain the gain value, and adjust the gain value received by the communication apparatus 100. Finally, the demodulator 140 receives and demodulates the digit signal.

As shown in FIG. 1B, the AGC update period of prior art in illustrated. Among these, the automatic gain control apparatus 130 includes a rapid period 150 and a normal period 160. As shown in FIG. 1A, the gain apparatus 1304 in the automatic gain control apparatus 130 uses a fixed AGC update period to receive the digital signal. At this time, if the signal received by the receiver is under the fast fading status, it will not be suitable for too slow AGC update period shown in FIG. 1B. Similarly, if the signal received by the receiver is under the slow fading status, it will not be suitable for too fast AGC update period.

Thus, it is necessary to provide a communication apparatus with automatic gain control apparatus and automatic gain control method, in order to adjust the AGC update period in accordance with the received signal at any time.

### SUMMARY OF THE INVENTION

The main purpose of the invention is to provide a communication apparatus with automatic gain control apparatus and automatic gain control method, so that the communication apparatus can detect the status of signal in time, and adjust the AGC update period automatically at any time.

A purpose of the invention is to provide a communication apparatus with automatic gain control apparatus, comprising a radio frequency tuner, which is used to receive the first analog signal; an analog and digital conversion apparatus, which is electrically connected to the radio frequency tuner, and is used to convert the first analog signal into a first digital signal; an automatic gain control apparatus, comprising a signal power calculation apparatus, which is used to calculate a first power value of the first digital signal; a gain apparatus, including a corresponding power gain table, which is used to inquire inside corresponding power gain table to obtain a first gain value in accordance with the first power value; a channel status decision apparatus, which is used to decide a first channel status of the first digital signal; and a demodulator, which is electrically connected to the automatic gain control apparatus, and is used to receive and demodulate the first digit signal; among these, the first digital signal has the AGC update period, the demodulator sends out the first channel impulse response signal to the automatic gain control apparatus, and the channel status decision apparatus adjusts the AGC update period in accordance with the first channel status of the first digital signal.

According to the above-mentioned idea, the AGC update period further includes a rapid AGC period and a normal AGC period.

According to the above-mentioned idea, when the first channel status is under the fast fading status, the channel status decision apparatus will adjust the rapid AGC period to the fast fading AGC period.

According to the above-mentioned idea, the fast fading AGC period further includes a fast fading rapid AGC period and a fast fading normal AGC period.

According to the above-mentioned idea, when the first channel status is under the slow fading status, the channel status decision apparatus will adjust the rapid AGC period to the slow fading AGC period.

According to the above-mentioned idea, the slow fading AGC period further includes a slow fading rapid AGC period and a slow fading normal AGC period.

Another purpose of the invention is to provide an automatic gain control method of communication apparatus with automatic gain control apparatus, comprising an automatic gain control apparatus to receive the first digital signal; an automatic gain control apparatus uses the first AGC update period as the initial AGC update period; a signal power calculation apparatus in the automatic gain control apparatus calculates the first power value of the first digital signal; the signal power calculation apparatus uses the corresponding power gain table included in the signal power calculation apparatus to inquire the corresponding first gain value in accordance with the first power value; a gain apparatus in the automatic gain control apparatus sets up the gain value for next period of communication apparatus as the second gain value in accordance with the first power value; and a channel status decision apparatus in the automatic gain control apparatus decides the first channel status of the first digital signal, and transmits the first channel impulse response signal to control the communication apparatus, the communication apparatus sets up next period as the second AGC update period in accordance with the first channel impulse response signal.

According to the above-mentioned idea, the first AGC update period further includes a first rapid AGC period and a first normal AGC period.

According to the above-mentioned idea, the second AGC update period further includes a second rapid AGC period and a second normal AGC period.

According to the above-mentioned idea, when the first channel status is under the fast fading status, the channel status decision apparatus will adjust the second rapid AGC period to the fast fading AGC period.

According to the above-mentioned idea, the fast fading AGC period further includes the fast fading rapid AGC period and the fast fading normal AGC period.

According to the above-mentioned idea, when the first channel status is under the slow fading status, the channel status decision apparatus will adjust the second rapid AGC period to the slow fading AGC period.

According to the above-mentioned idea, the slow fading AGC period further includes the slow fading rapid AGC period and the slow fading normal AGC period.

Therefore, the advantage and spirit of the invention can be understood further by the following detail description of invention and attached Figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a graph illustrating the communication apparatus having the automatic gain control system of prior art.

FIG. 1B is a graph illustrating the AGC update period of prior art.

FIG. 2 is a graph illustrating the communication apparatus having automatic gain control apparatus of the invention.

FIG. 3 is a graph illustrating the flow chart of automatic gain control method for the communication apparatus with automatic gain control apparatus.

### DESCRIPTION OF THE PREFERRED EMBODIMENT

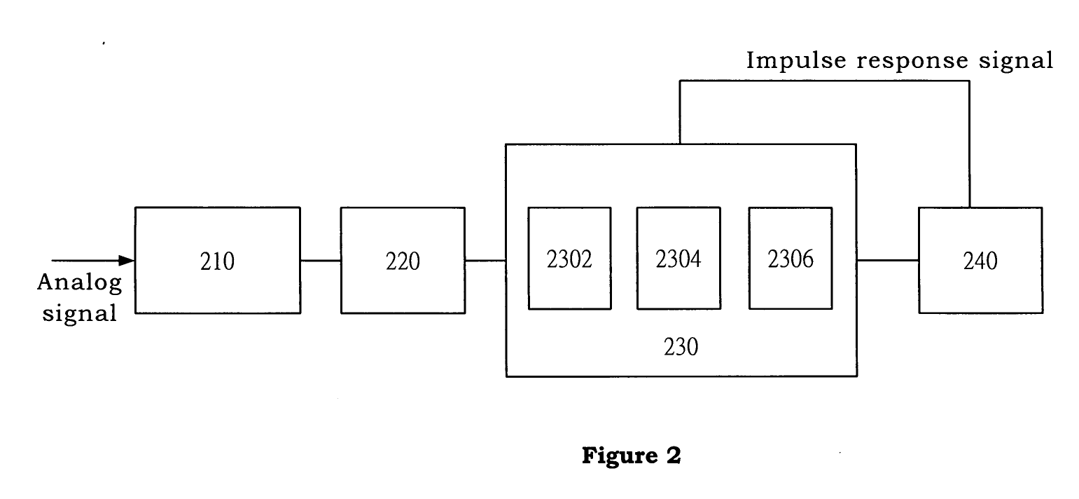

Please refer to FIG. 2 for the communication apparatus 200 having automatic gain control apparatus of the invention.

As shown in FIG. 2, a radio frequency tuner 210 receives a first analog signal, an electrically connected analog and digital conversion apparatus 220 of the radio frequency tuner 210 converts the first analog signal to a first digital signal. An automatic gain control apparatus 230 receives the first digital signal and treats it, wherein the automatic gain control apparatus 230 includes a signal power calculation apparatus 2302, a gain apparatus 2304, and a channel status decision apparatus 2306.

Firstly, as shown in FIG. 2, the first digital signal is calculated by the signal power calculation apparatus 2302 to obtain a first power value. Then, the gain apparatus 2304 includes a corresponding power gain table, which is used to inquire the first gain value in accordance with the first power value. The gain apparatus 2304 controls the gain value in accordance with the first gain value. Finally, the channel status decision apparatus 2306 decides the first channel status via the first digital signal. A demodulator 240 electrically connected to the automatic gain control apparatus 230 is used to receive and demodulate the first digit signal.

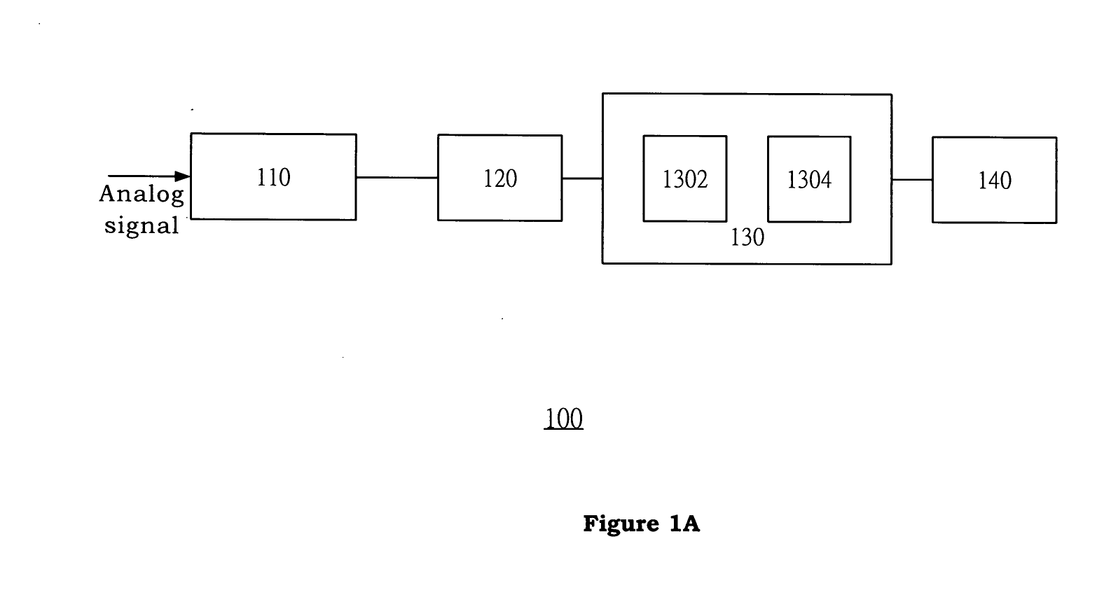

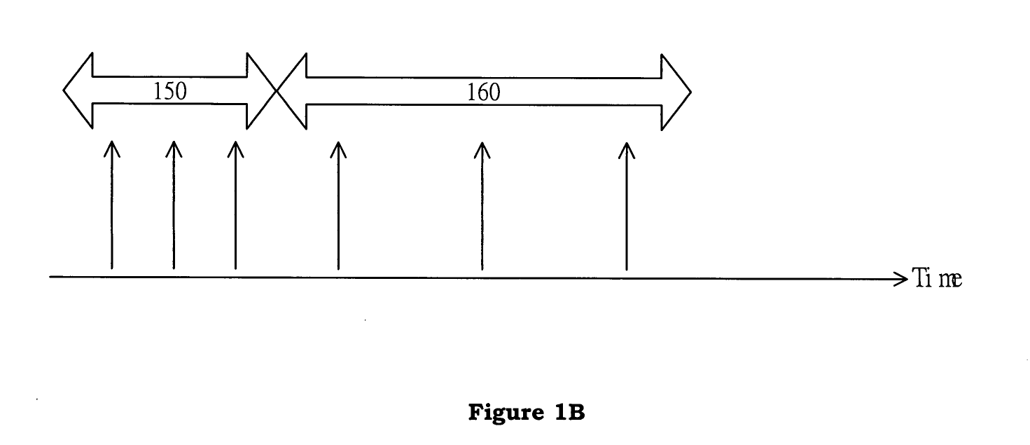

In the embodiment, the communication apparatus 200 defaults an AGC update period as the initial AGC update period, and the automatic gain control apparatus 230 uses this initial AGC update period to receive the first digital signal. The first digital signal is calculated by the signal power calculation apparatus 2302 to obtain the first power value. The gain apparatus 2304 calculates to obtain the first gain value in accordance with the first power value; and sets up the second gain value of AGC update period (i.e. the first AGC update period) in accordance with the first power value. The demodulator 240 sends out the first channel impulse response signal to the automatic gain control apparatus 230. The channel status decision apparatus 2306 adjusts the AGC update period in accordance with the first channel status of the first digital signal. As shown in FIG. 1B, the AGC update period further includes a rapid period and a normal period.

In another embodiment, when the channel status decision apparatus 2306 decides the first channel status is under the fast fading status, the channel status decision apparatus 2306 will adjust the rapid AGC period to the fast fading AGC period. The fast fading AGC period further includes a fast fading rapid AGC period and a fast fading normal AGC period.

In another embodiment, when the channel status decision apparatus 2306 decides the first channel status is under the slow fading status, the channel status decision apparatus 2306 will adjust the rapid AGC period to the slow fading AGC period. The slow fading AGC period further includes the slow fading rapid AGC period and the slow fading normal AGC period.

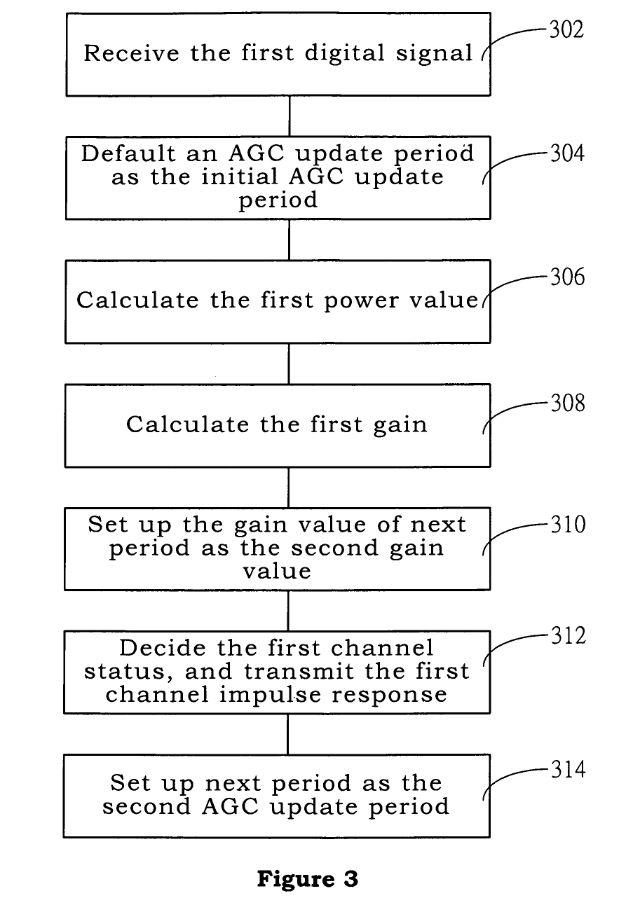

FIG. 3 is a preferred embodiment illustrating the communication apparatus 200 (shown in FIG. 2) with automatic gain control apparatus 230 and the flow chart of automatic gain control method.

As shown in Step 302 of FIG. 3, the automatic gain control apparatus 230 receives the first digital signal.

As shown in Step 304 of FIG. 3, the first AGC update period is used as the initial AGC update period.

As shown in Step 306 of FIG. 3, the signal power calculation apparatus 2302 calculates the first power value of the first digital signal.

As shown in Step 308 of FIG. 3, the gain apparatus 2304 inquires the first gain value in accordance with the first power value via a corresponding power gain table included in it.

As shown in Step 310 of FIG. 3, the gain apparatus 2304 sets up the gain value for next period of communication apparatus 200 as the second gain value in accordance with the first power value.

As shown in Step 312 of FIG. 3, the channel status decision apparatus 2306 in the automatic gain control apparatus 230 decides the first channel status of the first digital signal, and transmits the first channel impulse response signal to control the communication apparatus 200.

As shown in Step 314 of FIG. 3, the communication apparatus 200 sets up next period as the second AGC update period in accordance with the first channel impulse response signal. Among them, the first AGC update period further includes a first rapid AGC period and a first normal AGC period. The second AGC update period further includes a second rapid AGC period and a second normal AGC period.

In another embodiment, when the first channel status is under the fast fading status, the channel status decision apparatus 2306 will adjust the rapid AGC period to the fast fading AGC period. The fast fading AGC period further includes a fast fading rapid AGC period and a fast fading normal AGC period.

In another embodiment, when the first channel status is under the slow fading status, the channel status decision apparatus 2306 will adjust the rapid AGC period to the slow fading AGC period. The slow fading AGC period further includes a slow fading rapid AGC period and a slow fading normal AGC period.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A communication apparatus having automatic gain control apparatus, comprising:
a radio frequency tuner for receiving a first analog signal;
an analog and digital conversion apparatus, being electrically connected to the radio frequency tuner, and to convert the first analog signal into a first digital signal;
an automatic gain control apparatus, comprising:
a signal power calculation apparatus, calculating a first power value of the first digital signal;
a gain apparatus, including a corresponding power gain table, inquiring inside corresponding power gain table to obtain the first gain value in accordance with the first power value; and
a channel status decision apparatus, deciding the first channel status of the first digital signal; and
a demodulator, being electrically connected to the automatic gain control apparatus, and receiving and demodulating the first digit signal;
wherein the first digital signal has the automatic gain control update period, the demodulator sends out the first channel impulse response signal to the automatic gain control apparatus, and the channel status decision apparatus adjusts the automatic gain control update period in accordance with the first channel status of the first digital signal.

2. The apparatus according to claim 1, wherein the automatic gain control update period further comprises a rapid automatic gain control period and a normal automatic gain control period.

3. The apparatus according to claim 2, wherein when the first channel status is under the fast fading status, the channel status decision apparatus comprises adjusting the rapid automatic gain control period to a fast fading automatic gain control period.

4. The apparatus according to claim 3, wherein the fast fading automatic gain control period further comprises a fast fading rapid automatic gain control period and a fast fading normal automatic gain control period.

5. The apparatus according to claim 2, wherein when the first channel status is under the slow fading status, the channel status decision apparatus comprises adjusting the rapid automatic gain control period to a slow fading automatic gain control period.

6. The apparatus according to claim 5, wherein the slow fading automatic gain control period further comprises a slow fading rapid automatic gain control period and a slow fading normal automatic gain control period.

7. An automatic gain control method, the steps comprising:
receiving a first digital signal by an automatic gain control apparatus;
using a first automatic gain control update period as a initial automatic gain control update period by an automatic gain control apparatus;
calculating a first power value of the first digital signal by a signal power calculation apparatus in the automatic gain control apparatus;
using a corresponding power gain table included in the signal power calculation apparatus to inquire a corresponding first gain value in accordance with a first power value by the signal power calculation apparatus;
setting up a gain value for a next period of communication apparatus as a second gain value in accordance with the first power value by a gain apparatus in the automatic gain control apparatus; and
deciding a first channel status of the first digital signal by a channel status decision apparatus in the automatic gain control apparatus, and transmitting a first channel impulse response signal to control a communication apparatus, the communication apparatus setting up next period as a second automatic gain control update period in accordance with the first channel impulse response signal.

8. The method according to claim 7, wherein the first automatic gain control update period further comprises a first rapid automatic gain control period and a first normal automatic gain control period.

9. The method according to claim 8, wherein the second automatic gain control update period further comprises a second rapid automatic gain control period and a second normal automatic gain control period.

10. The method according to claim 9, wherein when the first channel status is under the fast fading status, the channel status decision apparatus comprises adjusting the second rapid automatic gain control period to the fast fading automatic gain control period.

11. The method according to claim 10, wherein the fast fading automatic gain control period further comprises a fast fading rapid automatic gain control period and a fast fading normal automatic gain control period.

12. The method according to claim 9, wherein when the first channel status is under the slow fading status, the channel status decision apparatus comprises adjusting the rapid automatic gain control period to the slow fading automatic gain control period.

13. The method according to claim 12, wherein the slow fading automatic gain control period further comprises a slow fading rapid automatic gain control period and a slow fading normal automatic gain control period.
